(19) United States
(12) Patent Application Publication
(10) Pub. No.: US 2023/0019222 A1
(43) Pub. Date: Jan. 19, 2023

(54) Interactive Instructional Aid

(71) Applicant: Rick Clark, Cumming, GA (US)

(72) Inventor: Rick Clark, Cumming, GA (US)

(21) Appl. No.: 17/867,007

(22) Filed: Jul. 18, 2022

Related U.S. Application Data
(60) Provisional application No. 63/223,376, filed on Jul. 19, 2021.

(51) Int. Cl. G09B 19/00; G09B 5/02

(52) U.S. Cl. CPC G09B 19/003; G09B 5/02

(57) ABSTRACT

An instructional aid device is provided. The device includes a plurality of individual pages which can be fixed or removably secured within a binder or binding. The individual pages include various instructions that can be used for any type of product assembly, directions on a do-it-yourself project, and educational manuals. One embodiment of the instructions is a cookbook that includes recipes for cooking different types of foods. Each instruction page includes a scannable code that is configured to automatically redirect the scanning device, such as a smartphone, to a website that includes instructional information. The device is configured to automatically display parts or ingredient types and amounts in the screen background over time, in order to provide continuous instruction to the user while they are executing a project or preparing the recipe.

### CROSS REFERENCE TO RELATED APPLICATIONS

This application claims the benefit of U.S. Provisional Application No. 63/223,376 filed on Jul. 19, 2021. The above identified patent application is herein incorporated by reference in its entirety to provide continuity of disclosure.

### BACKGROUND OF THE INVENTION

The present invention relates to an instructional aid. More specifically, the present invention provides a plurality of individual pages which includes a scannable code disposed on at least one individual page, whereby the scannable code is configured to redirect an electronic device to a website with virtual instructions coinciding with a set of instructions disposed within the instructional aid.

With the accessibility to an abundance of information online, people prefer to perform ‘do-it-yourself’ tasks around their house. Whether the task involves the building of furniture, making repairs, or preparing a specific food dish, individuals will prefer to use instructional resources readily available at their disposal to assist them with performing the task. Additionally, the ability to do tasks by oneself provides the individual with the chance to save money from not having to pay a professional for their time and labor. Typically, an instructional resource will inform the individual of the necessary supplies or tools they may purchase to complete the task. Moreover, if the task involves something foreign to the user and they began with no initial knowledge of how to complete the task, individuals gain a sense of accomplishment that comes with performing such a task on their own.

With the vast array of information that is accessible to individuals online and through other means, it can often be overwhelming for the individual to find a useful set of instructions. A useful set of instructions will not only assist the individual in completing the task, but it will also convey the necessary information in a way for the individual to easily comprehend each step. To find such resources, it may be common for an individual to spend an unnecessary amount of time reviewing information online to determine if that set of instructions can allow them to reach the objective in an efficient matter.

The majority of resources that provide a pure form of instructional information for individuals may be placed within a book, magazine, booklet, or the like. While these types of media can provide a lot of information to help an individual perform a desired task, it can be difficult to follow along solely using written information. Depending on the task described within these resources, many individuals wish to have further references or media to help provide further information to assist in accomplishing the task. Moreover, some individuals prefer visuals, such as figures and videos, to demonstrate each step along the way and how to complete each step. In this way, the user will be able to complete each step comfortably and reduce the stress that the entire task may entail, which might ultimately prevent the task from being completed. Unfortunately, many resources lack the visual aspects that may be helpful to users when following a recipe or making a repair. Even if one method if completing the task is more effective than the other, often it is beneficial to the individual to have different options to help convey the important information to ultimately accomplish the task.

Even so, individuals that are using a media source, like a video, to help guide them as they accomplish a desired task, may have difficulty following along. Typically, the user is watching the video and performing the task at the same time. This attempt to multitask can result in the user becoming distracted and missing a step. When this happens, the user will have to rewind the video until they complete the missed step, otherwise missing the step in the middle of the process can affect the final results of the task. Having to constantly rewind the instructional video will ultimately prolong the process of completing the desired task.

Therefore, there is a defined need amongst the known prior art references for an instructional aid that provides a set of instructions and direct a user to an interactive video to accompany the instructions via a scannable code.

### SUMMARY OF THE INVENTION

In view of the foregoing disadvantages inherent in the known types of instructional aids now present in the known art, the present invention provides a plurality of individual pages within a common binding, wherein each page includes a scannable code that causes the scanner to automatically display a video that updates in real time when each step is completed by the user.

It is therefore an object of the present invention to provide an instructional aid with a plurality of demonstrative methods to assist a user in accomplishing a task. The scannable code disposed on the individual pages in the instructional aid will direct the user's electronic device to a website or other media when scanned. The additional information that the user receives on the website or other media will be able to provide another method for the user to utilize to accomplish the desired task. Additionally, the information that is on the electronic device following the scanning of the scannable code can include an interactive video. In the interactive video, the video will play in steps. The interactive video will not proceed to the next step until the user accomplishes each step. This will assure the user that they will not miss any steps as they attempt to view the interactive video and perform the task at the same time. In this way, the task may be performed properly and timely as the user receives additional resources to assist in the completion of the desired task.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the instructional aid.

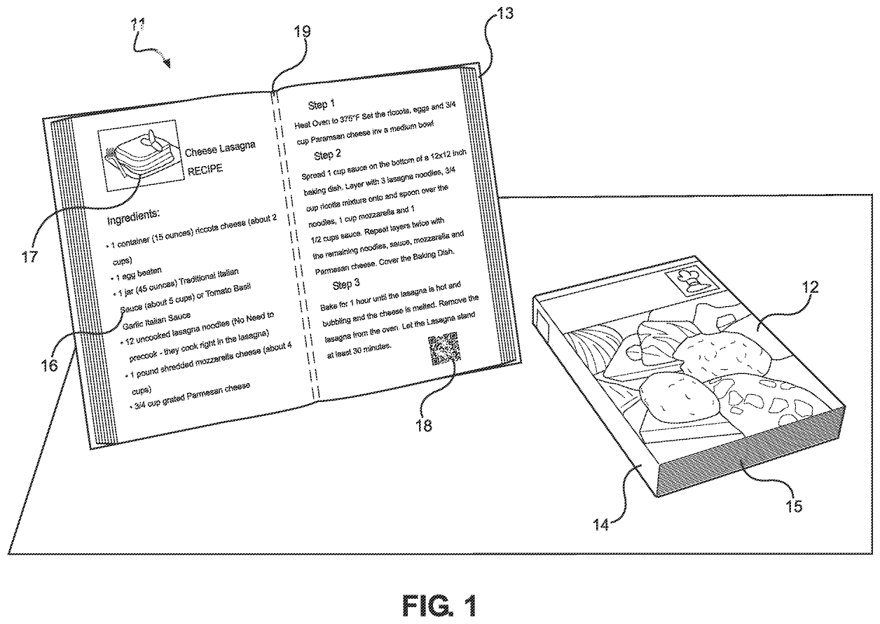

FIG. 2 shows a perspective view of an embodiment of the instructional aid in use.

FIG. 3 shows a perspective view of an embodiment of the instructional aid in use.

### DETAILED DESCRIPTION OF THE INVENTION

Reference is made herein to the attached drawings. Like reference numerals are used throughout the drawings to depict like or similar elements of the instructional aid. The figures are intended for representative purposes only and should not be limiting in any respect.

[symbol] shows a perspective view of an embodiment of an instructional aid. The instructional aid 11 comprises a front cover 12 and a rear cover 13. The front cover 12 and the rear cover 13 are connected via a binding 14, wherein the binding 14 is sandwiched between the front cover 12 and the rear cover 13. The binding 14 includes an internal face. The internal face of the binding 14 comprises a plurality of individual pages 15. In one embodiment the internal face of the binding 14 comprises a plurality of rings. The plurality of rings allows the instructional aid 11 to be a binder. In said embodiment, the plurality of individual pages 15 further includes at least one aperture. The at least one aperture is positioned on the edge of each individual page of the plurality of individual pages 15. In this embodiment, each individual page of the plurality of individual pages may be selectively removed from the plurality of rings.

In the shown embodiment of the instructional aid 11, the plurality of individual pages 15 is affixed to the binding 14. A first edge of each individual page of the plurality of individual pages 15 is attached to the internal face of the binding 14. In this embodiment, the plurality of individual pages 15 further comprises a perforation 19. The perforation extends the length of each individual page. Whereby the perforation 19 is parallel with the first edge of each individual page. In this configuration, a user may remove an individual page from the instructional aid 11 by tearing along the perforation 19.

The plurality of individual pages 15 contains a set of instructions 16 disposed thereon. The plurality of individual pages 15 is grouped together depending on the type of information is contained within the set of instructions 16. The set of instructions 16 provide a step-by-step guide to perform a desired task. In one embodiment, the set of instructions 16 comprises a dish recipe. In another embodiment, the set of instructions 16 comprises a set of repair instructions. In yet another embodiment, the set of instructions 16 comprises a set of building instructions. Moreover, a figure 17 is disposed on the plurality of individual pages 15. The figure 17 provides a visual guide to assist in the comprehension of the set of instructions 16. Moreover, a scannable code 18 is disposed on the plurality of individual pages 15. The scannable code 18 is associated with the desired task set forth in the set of instructions 16. Moreover, in a group of plurality of individual pages 15 accomplishing a single desired task, the set of instructions 16, the figure 17, and the scannable code 18 will assist the user in accomplishing the desired task. In one embodiment, the scannable code 18 is a quick response code. The scannable code 18 may link to a website or other link that can provide further instructions or additional media to assist in the completion the desired task.

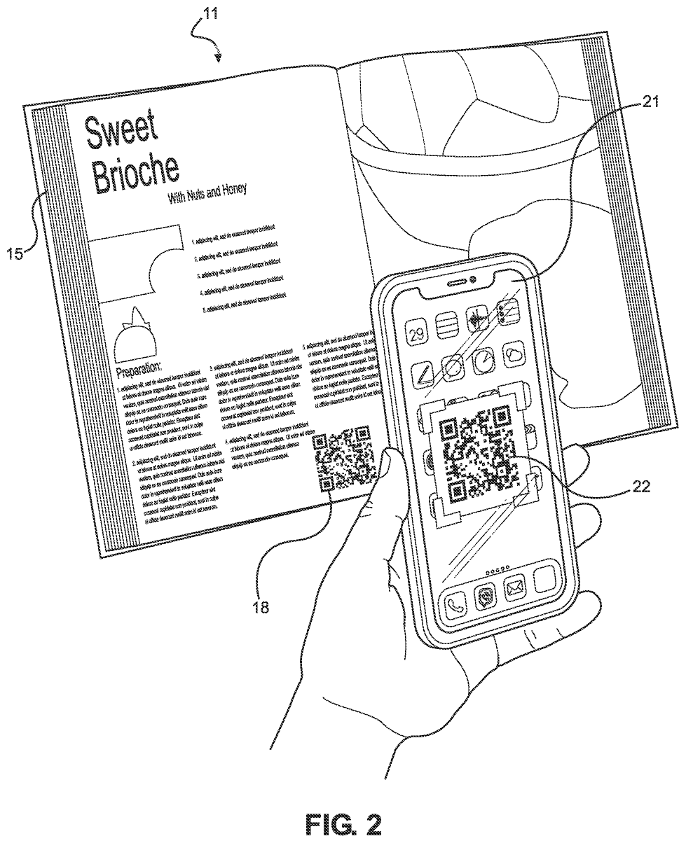

FIG. 2 shows a perspective view of an embodiment of an instructional aid in use. The instructional aid 11 includes the plurality of individual pages 15 connected to the binding and sandwiched between both the front cover and the rear cover. In use, the user will open the instructional aid 11 to a specific individual page of the plurality of individual pages 15 which includes a task which the user wishes to complete. When the instructional aid 11 is open to the specific individual page, the scannable code 18 associated with the task described on the individual page will be disposed on the same individual page. A user may take an electronic device 21 and launch an application 22 that scans the scannable code 18. The application 22 will utilize a camera system within the electronic device 21 to scan the scannable code 18 disposed on the individual page. When the electronic device 21 scans the scannable code 18, the application 22 will redirect the electronic device 21 to the website or other media which is associated with the task that is displayed on the individual page along with the scannable code 18.

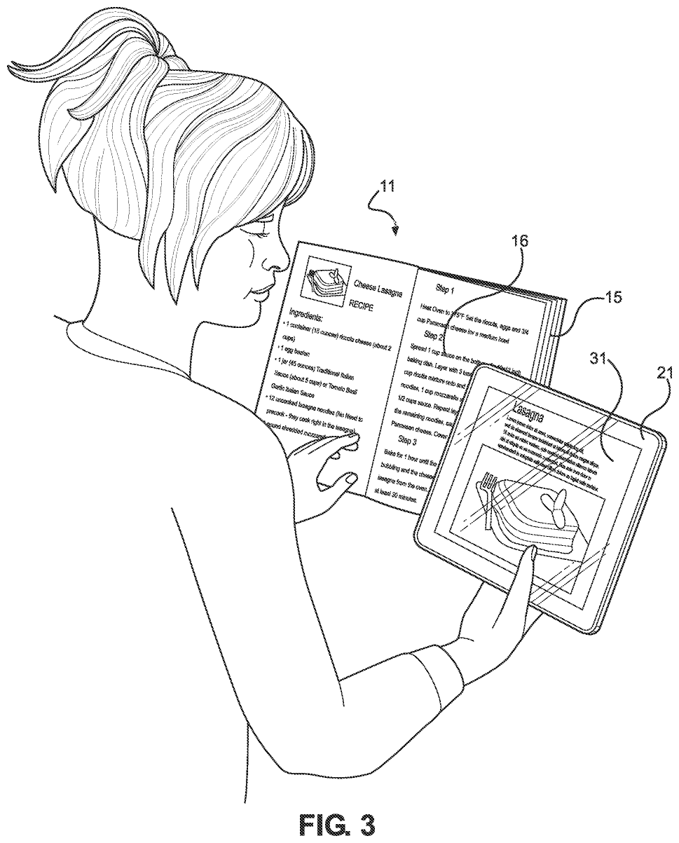

FIG. 3 shows a perspective view of an embodiment of an instructional aid in use. In use, the user will operate the electronic device 21 to scan the scannable code disposed on an individual page of the plurality of individual pages 15 within the instructional aid 11. The scannable code is linked to a website or other media 31. The electronic device 21 will launch the website or other media 31 following the scanning of the scannable code. The website or other media 31 may comprise of a plurality of additional information that will help the user complete the desired task that is associated with the scannable code within the instructional aid 11. The plurality of additional information may include an interactive video. Moreover, the interactive video may update in real-time when each instruction of the set of instructions is completed. For example, if the instruction set is displaying a recipe, the interactive video may update in real-time when each ingredients amount is added to the dish and provides information to the user as they prepare the recipe. In the one embodiment, the interactive video will include the ability to track the steps. With the step tracking ability, the video will progress with the user as they complete the desired task. This process may be performed automatically or manually. When perform manually, the user selectively advances the interactive video when the step is completed. In one embodiment, the user indicates on the electronic device that the present step is completed by engaging a proceed option on the interactive video. Engaging the proceed option advances the interactive video to a subsequent step in the desired task. The plurality of additional information may include additional figures and diagrams which can help with a step-by-step instruction set. The plurality of additional information may include hints and tricks that can assist the user in completing the task beyond the set of instructions disposed on the plurality of individual pages 15.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An instructional aid, comprising:
a front cover and a rear cover;
whereby a binding connects the front cover to the rear cover;
a plurality of individual pages coupled with the binding, wherein the plurality of individual pages is sandwiched between the front cover and the rear cover;
whereby a first edge of each individual page of the plurality of individual pages is attached to an internal face of the binding;
the plurality of individual pages further includes a set of instructions;
a scannable code is disposed on the plurality of individual pages;
whereby an electronic device scans the scannable code to launch a website that corresponds with the scannable code;
wherein the website provides additional aid regarding the set of instructions disposed on an individual page of the plurality of individual pages with the scannable code; and
wherein the additional aid linked to the website includes an interactive video, whereby the interactive video updates in real-time when each instruction of the set of instructions is completed.

2. The instructional aid of claim 1, wherein each individual page of the plurality of individual pages is removeable from the binding.

3. The instructional aid of claim 1, wherein each individual page further includes a perforation, whereby the perforation is parallel with the first edge of each individual page of the plurality of individual pages.

4. The instructional aid of claim 1, wherein the set of instructions includes a recipe.

5. The instructional aid of claim 1, wherein the set of instructions includes a textual description of necessary components for a project.

6. The instructional aid of claim 1, wherein the set of instructions includes a set of step-by-step instructions on how to utilize the necessary components for a project.

7. The instructional aid of claim 1, wherein the scannable code is a quick response code.

8. The instructional aid of claim 1, wherein the interactive video includes is a proceed option to update the interactive video in real-time when an instruction of the set of instructions is completed.

9. The instructional aid of claim 1, wherein the plurality of individual pages further includes an image.
